(19) United States
(12) Patent Application Publication
(10) Pub. No.: US 2024/0046117 A1
(43) Pub. Date: Feb. 8, 2024

(54) SYSTEM AND METHOD FOR FACILITATING FLEXIBLE AND HIERARCHICAL STORAGE AND MANAGEMENT OF KNOWLEDGE

(71) Applicant: TENGRAM TECHNOLOGIES PRIVATE LIMITED, New Delhi (IN)

(72) Inventors: Himanshu Arya RAWAT, New Delhi (IN); Rajat PATEL, Kanpur Nagar (IN)

(21) Appl. No.: 18/265,311

(22) PCT Filed: Dec. 3, 2021
(86) PCT No.: PCT/IB2021/061308

§ 371 Date: Jun. 5, 2023

(30) Foreign Application Priority Data
Dec. 5, 2020 (IN) 202011053007

(51) Int. Cl. G06N 5/022

(52) U.S. Cl. CPC G06N 5/022

(57) ABSTRACT

The present disclosure relates to system and method for facilitating management and storage of knowledge. According to the method, a first set of data packets is received from a computing device associated with a user, where the first set of data packets corresponds to knowledge data and metadata comprises a set of members associated with the knowledge data. Upon receipt of the data packets, a first, a second, and a third set of members are identified from among the set of members based on a hierarchical level of the set of members, where each of the first members is associated with at least one of the second set of members, and wherein each of the second set of members is associated with at least one of the third set of members. Upon identification, members of the root repository based on the first set of members, members of the namespace repository based on the second set of members, and members of the work repository based on the third set of members are generated. The knowledge data is stored in the corresponding work repository and metadata associated with each repository is stored in the corresponding repositories.

### TECHNICAL FIELD

The present disclosure relates to a system and a method for facilitating the storage of information and in particular to a method for creating, storing, accessing, and managing knowledge in an organization.

### BACKGROUND

Background description includes information that may be useful in understanding the present invention. It is not an admission that any of the information provided herein is prior art or relevant to the presently claimed invention, or that any publication specifically or implicitly referenced is prior art.

An organizational structure of an organization is conceptual and is not visible to the naked eye. The organizational structure and management hierarchy are learnt over-rules acquired by the individual while working at the organization. The leadership defines the organizational structure and management hierarchy on paper and instructs the management below to implement it organization-wide. The implementation of the organization structure can be actively supervised in a physical office but is very difficult to supervise electronically. In the present times, every organization is heavily dependent on various digital applications to carry out business operations. Every department is employed with task-specific. collaboration tools which perform the corresponding functions independently in silos. However, these digital silos suffer from a lack of understanding as to how a particular department or team fits into the bigger picture. In addition, the traditional tools only provide the task-specific collaboration environment but fail to implement the management hierarchical organization. Moreover, the collaboration tools are loosely coupled within the organizational structure and management hierarchy. The casual coupling creates various blind spots and overlaps making the overall administration of the organization difficult and non-coherent, eventually decreasing the overall efficiency of the organization.

Furthermore, every organization has a different organizational structure and management hierarchy. The organization structure and management hierarchy vary to a great extent and therefore it was very difficult to exactly replicate the organizational structure electronically. Further, the user has to independently learn the operability of each system and has to adhere to the premade hierarchy provided by each distinct application. Correspondingly, the organization has to modify or rearrange its management hierarchy and organizational structure in accordance with the digital application. As there are multiple technological solutions in the market, one cannot modify management hierarchical organization consistently for every subscribed application. If one wants a modified technological solution as per the personal requirements of the organization structure and management hierarchy, it would require manual programming which involves a heavy cost to the organization. The structure and implementation varies from digital application to application and organisation to organisation without any uniformity in the system operability. The non-uniformity of the structure poses a technical challenge in reusability and resource sharing between different technological applications.

Hence, there is a requirement to devise a system and a method for facilitating an effortless way for the user to automatically create, operate, manage and administer an organization structure and management hierarchy independent of any specific application and any specific organization.

### SUMMARY

The present disclosure relates to a system and a method for facilitating and storage of information and in particular to a method for creating, storing, accessing, and managing knowledge in an organization.

An aspect of the present disclosure pertains to a system for facilitating digital organization structure and management hierarchy. The system includes a storage device including a plurality of repositories operatively coupled to one or more computing devices, the plurality of repositories can be configured to store knowledge data and metadata associated with knowledge data and corresponding repository in a hierarchical manner, the plurality of repositories comprises a root repository, a namespace repository, and a work repository, wherein members of the root repository, namespace repository, and work repository are associated with each other in a hierarchical manner; and a monitoring unit having a processor operatively coupled to a memory, the memory storing instructions executable by the processor to: receive a first set of data packets from a computing device associated with a user, the first set of data packets corresponding to knowledge data and metadata comprises a set of members associated with the knowledge data; identify a first, a second, and a third set of members from among the set of members based on a hierarchical level of the set of members, wherein each of the first members is associated with at least one of the second set of members, and wherein each of the second set of members is associated with at least one of the third set of members; generate members of the root repository based on the first set of members, members of the namespace repository based on the second set of members, and members of the work repository based on the third set of members; and store the knowledge data in the corresponding work repository and store metadata associated with each repository in the corresponding repositories.

According to an embodiment, the second set of members comprises a plurality of subsets of members, wherein each subset of members is associated with a mounting level indicating the hierarchical level within the second set of members, wherein the subset of members is stored along with the corresponding mount level. In an example, the members associated with a first mount level comprise the members associated with a second mount level.

According to an embodiment, the processor is configured to: generate a root ID indicating a unique identification key corresponding to each of the members of the root repository; generate a namespace ID indicating a unique identification key corresponding to each of the members of the namespace repository; generate a work ID indicating a unique identification key corresponding to each of the members of the work repository; and store the root ID along with the first set of members.

According to an embodiment, the processor is configured to generate a knowledge index indicating the location of memory blocks where the knowledge data is stored and type of the knowledge data; and store the knowledge index along with the third set of members.

According to an embodiment, the processor is configured to provide access to a user based on the association of the user with the corresponding repository to be accessed.

According to an embodiment, the processor is configured to obtain login credential details from the user and provide access to the user in case the obtained credential matches with the pre-stored credentials.

According to an embodiment, the processor is configured to maintain an account database to store the identification key of the plurality of repositories.

According to an embodiment, the computing device comprises a display unit configured to provide a graphical user interface between the user and the system.

According to an embodiment, the namespace members are associated with a silo function that creates further namespace members on the basis of its active or inactive state

In another aspect of the present disclosure pertains to a method for facilitating digital organization structure and management hierarchy. The method includes receiving, by one or more processors, a first set of data packets from a computing device associated with a user, the first set of data packets corresponding to knowledge data and metadata, wherein the meta data comprises information of a set of members associated with the knowledge data; identifying, by the one or more processors, a first, a second, and a third set of members from among the set of members based on a hierarchical level of the set of members, wherein each of the first members is associated with at least one of the second set of members, and wherein each of the second set of members is associated with at least one of the third set of members; generating, by the one or more processors, members of the root repository based on the first set of members, members of the namespace repository based on the second set of members, and members of the work repository based on the third set of members; and storing, by the one or more processors, the knowledge data in the corresponding work repository and store metadata associated with each repository in the corresponding repositories.

Various objects, features, aspects, and advantages of the inventive subject matter will become more apparent from the following detailed description of preferred embodiments, along with the accompanying drawing figures in which like numerals represent like components.

### BRIEF DESCRIPTION OF THE DRAWINGS

In the figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary network architecture in which or with which the proposed system can be implemented in accordance with an embodiment of the present disclosure.

FIGS. 2A-2C illustrates an exemplary architecture of a monitoring unit, repository ladder processing interface, and a service level unit, in accordance with embodiments of the present disclosure.

FIG. 3 illustrates an exemplary representation of a flow diagram showing the method for facilitating digital organization structure and management hierarchy in accordance with an embodiment of the present disclosure.

FIG. 4 illustrates a block diagram of an exemplary implementation of logical schema showing level of interactions between plurality of repositories in accordance with an embodiment of the present disclosure.

FIG. 5 illustrates an exemplary block diagram depicting components of a computing device associated with a user in accordance with an embodiment of the present disclosure.

FIG. 6 illustrates an exemplary representation of the hierarchy structure being managed by the proposed system, in accordance with embodiments of the present disclosure.

FIGS. 7A-7F illustrates exemplary widgets showing the user interface for receiving the user input, in accordance with embodiments of the present disclosure.

FIG. 8 illustrates an exemplary representation of widget showing members of the work repository, in accordance with embodiments of the present disclosure.

### DETAILED DESCRIPTION

In the following description, numerous specific details are set forth in order to provide a thorough understanding of embodiments of the present invention. It will be apparent to one skilled in the art that embodiments of the present invention may be practiced without some of these specific details.

The present disclosure provides for a system and a method for facilitating efficient automated management and storage of information in a system. Embodiments of the present invention may be provided as a computer program product, which may include a machine-readable storage medium tangibly embodying thereon instructions, which may be used to program a computer (or other electronic devices) to perform a process. The machine-readable medium may include, but is not limited to, fixed(hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions.

Various methods described herein may be practiced by combining one or more machine-readable storage media containing the code according to the present invention with appropriate standard computer hardware to execute the code contained therein. An apparatus for practicing various embodiments of the present invention may involve one or more computers (or one or more processors within a single computer) and storage systems containing or having network access to computer program(s) coded in accordance with various methods described herein, and the method steps of the invention could be accomplished by modules, routines, subroutines, or subparts of a computer program product.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein. Various modifications will be readily apparent to persons skilled in the art. Thus, the present invention is to be accorded the widest scope encompassing numerous alternatives, modifications, and equivalents consistent with the principles and features disclosed.

Systems depicted in some of the figures may be provided in various configurations. In some embodiments, the systems may be configured as a distributed system where one or more components of the system are distributed across one or more networks in a cloud computing system.

The term “knowledge” or “knowledge data” as is used herein, generally refers to a technical term used to describe a file, including but not limited to text, audio, video, programs, etc and the like produced or used by a user(interchangeably referred to as the client) or a machine in a digital environment to accomplish a specific personal or professional objective.

The term “repository” used herein refers to a shared data storage that stores objects and the metadata of its objects and the repository itself to help describe the repository and the objects stored inside of it for others. The metadata concerning the repository and its objects can be but not limited to descriptive, administrative, or structural. The objects can be discrete units of data resulting from the disintegration of files of various nature such as images, videos, documents, audio, spreadsheets, etc. ‘Repository’ is also used herein to explain storage-related functionalities.

Embodiments herein relate to a multi-level repository structure to facilitate flexible and hierarchical storage and management of knowledge. The multi-level repository structure includes a plurality of repositories, where each of the plurality of repositories is configured to manage knowledge data through associated metadata in a hierarchical structure. The plurality of repositories store metadata associated with the knowledge data. The metadata indicates, for example, information of users or objects or members to which the knowledge data belongs, the location of the memory blocks where the knowledge data is being stored, and so on. The metadata information e.g., members associated with the knowledge data are stored in a hierarchical structure. In an example, in the case of a repository ladder, the set of members are segregated into three sets of members, each is being stored in the corresponding repository among the three repositories of 3-tier structure. The proposed system can be implemented for any number of repository structure.

In an embodiment, the plurality of the repository may include a root repository, a namespace repository, and a work repository. The work repository is referred to as a shared storage that stores a variety of data bundled together with a unique identification key. The work repository can have a specific storage configuration to maintain and store the variety of data. The data variety can be on a basis including but not limited to, variation based on file formats such as text, audio, video, images, etc, data models, etc. The data model groups and organizes together distinct data sets based on a business or project requirement. For example, an application of a Task-list can have a variety of distinct data, such as list name, card name, card description, author, comments, etc. logically coupled together based on a business or project requirement. The work repository can store such variable logical data and other varieties of data. The work repository can have multiple storage configurations constituted by or spread over a combination of databases and storage devices. In an embodiment, a work repository can be coupled with a combination of service level processing units to allow users to collaborate, store, share, create, organize and edit knowledge. And, a work repository can collect and store data from these processing units. The namespace repository stores a collection of relative work repositories stored as a unit with a single name. The namespace repository further allows a user to create nested namespace repositories and work repositories. In other words, the namespace repository can include additional namespace repositories which can further store additional work repositories. Each repository can be considered its own namespace in which other repositories represent as namespaces are encapsulated within other repositories. The root repository acts as a root node for the namespace repositories and work repositories in a tree storage. The root repository is configured to store and maintain the tree data structures where the root repository is the very first node or default parent node which may further include one or more child nodes. Each child node in the root repository of the tree data structure represents the namespace repository and the work repository. The root repository is linked to a user account wherein the user account is set as the root repository.

In an embodiment, the set of data packets received from the computing device associated with the user can include any or a combination of length, structure, bits, and size of the data.

In an embodiment, the system can include a display unit operatively coupled to the processor and communicatively coupled to at least one of the computing devices associated with the user. The display device can be configured to create, view, consume, and modify data stored in the database.

In an embodiment, the display unit may include any or a combination of a smartphone, PC, laptop, and a smart tablet.

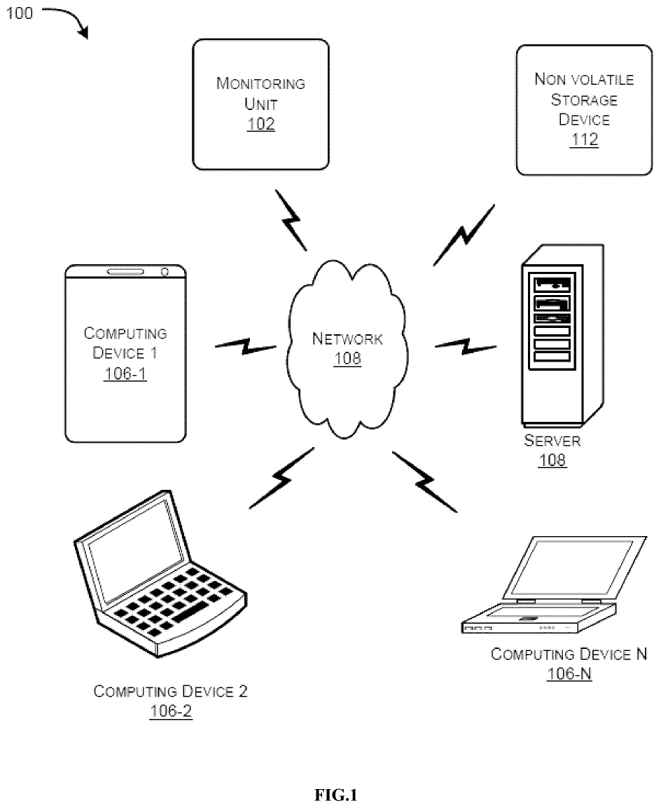

FIG. 1 illustrates an exemplary network architecture in which or with which the proposed system can be implemented in accordance with an embodiment of the present disclosure.

As illustrated in FIG. 1, according to an aspect of the present disclosure a knowledge management system 100 (also referred to as the system 100, hereinafter) can provide self-organizing and efficient management of knowledge obtained from one or more computing devices 106 (collectively referred to as computing devices 106 and individually referred to as computing device 106 hereinafter) associated with a user 110. The computing device 106 can be associated with a storage device 112 having a plurality of repositories through a network 104. The storage device 112 can also be communicatively coupled to a server 108 through network 104.

The storage device 112 may include, but is not limited to, hard disk drive (HDD), solid-state drive (SSD), and the like which can store huge amounts of data.

In a preferred embodiment, the storage device 112 can be coupled with any or a combination of a database. The storage unit associated with the storage device 112 can be further configured to include a plurality of repositories that can provide a flexible and a hierarchical structure to the database for storing knowledge.

Further, in an embodiment, the computing device 106 can be coupled to a monitoring unit 102 (referred to as monitoring unit 102 hereinafter). The monitoring unit 102 can be communicatively coupled with one or more computing devices 106 through the network 104.

In an embodiment, the system 100 can be implemented using any or a combination of hardware components and software components such as a cloud, a server, a computing device, a network device, and the like. Further, the system 100 can interact with computing devices 106 through the network 104.

In an implementation, network 104 can include any or a combination of a wireless network module, a wired network module, a dedicated network module, and a shared network module.

Furthermore, network 104 can be implemented as one of the different types of networks, such as Intranet, Local Area Network (LAN), Wide Area Network (WAN), Internet, and the like. The shared network can represent an association of the different types of networks that can use a variety of protocols, for example, Hypertext Transfer Protocol (HTTP), Transmission Control Protocol/Internet Protocol (TCP/IP), Wireless Application Protocol (WAP), and the like.

In an embodiment, the monitoring unit 102 can be configured to receive the first set of data packets from the computing device 106 associated with the user 110. The first set of data packets can correspond to a set of inputs pertaining to knowledge data and metadata comprises a set of members associated with the knowledge data. The set of members indicates the object or user to which the knowledge data belongs. In an example, in a case when the knowledge data is maintained in an educational institute, class standard, subject, and so on can be the member repositories. In this case, the school may be the first set of members to be stored in a root repository, where the class standard maybe a second set of members to be stored in a namespace repository, and where the subject maybe a third set of members to be stored in a work repository. School is the root repository aggregating all the departments, classes, subjects repositories. The class is the namespace repository containing all the subjects of the class and all of its members. The subject is the work repository containing all the knowledge related to the subject such as videos, documents, spreadsheets, etc.

In an embodiment, the monitoring unit 102 can be coupled to a non-volatile storage device 112 through the network 104. The non-volatile storage device 112 can support a plurality of repositories forming a plurality tier repository structure.

In a preferred embodiment, the plurality tier repository structure can include at least a three-tier repository structure (interchangeably referred to as repository ladder). The user 110 can manually create, configure and access a repository in any of the at least three tier repositories. In an exemplary embodiment, the at least three tier repository structure repository ladder can include the first repository (interchangeably referred to as “root repository” or “hive” hereinafter) which can be root level storage structural entity and can act as a central repository. The root repository can collate the data from the second and third repositories (interchangeably referred to as “namespace repository”/“cell repository” and “work repository”! “wall repository”, respectively) and can merge them into one so that the data may be shared, analyzed and accessed throughout an organization. The namespace repository collate data from the nested namespace repositories and work repository. In an embodiment, multiple first namespace repositories can simultaneously co-exist in a system, and each individual first namespace repository stores the mount level of its nested namespace repositories. In yet another exemplary embodiment, the work repository can act as a base storage structural entity acting as a collaborative repository for a user 110 to store, share, create and collect data while keeping a track of all the activities involved.

In an embodiment, the monitoring unit 102 may be operatively coupled to a memory. The memory stores a set of executable instructions, which upon execution cause the monitoring unit to perform a set of functions by the system. The monitoring unit 102 initially receives the first set of data packets from a computing device associated with a user. The first set of data packets may correspond to knowledge data and metadata. The metadata comprises information of a set of members associated with the knowledge data. In an example, the knowledge data may include an electronic file that may be configured for example in docx, pdf format, etc. The metadata may include information associated with the electronic file. For example, if the electronic file may include a scorecard, then the metadata may include school name, class information. In other words, the metadata may include a set of members associated with the knowledge data.

In an embodiment, upon receipt of the first set of data packets, a first, a second, and a third set of members from among the set of members is identified, where the identification may be performed based on a hierarchical level of the set of members. In an example, a class repository may be associated with the same set of member repositories. All the school repositories may be identified as the same set of member repositories. The school repository may be associated with a hierarchical level higher than a hierarchical level of the class repositories. Thus, based on the organizational structure or hierarchical level of the set of the members, the first, the second, and the third set of members are identified. The first set of members may have a higher level in a hierarchical structure as compared to the second set of members, and the second set of members may have a hierarchical level higher as compared to the third set of members.

In an embodiment, each of the first members is associated with at least one of the second set of members, where each of the second set of members is associated with at least one of the third set of members. In an embodiment, the monitoring unit may generate members of the root repository based on the first set of members, members of the namespace repository based on the second set of members, and members of the work repository based on the third set of members. In an embodiment, the first set of members, the second set of members, and the third set of members are already segregated while receiving the first set of data packets.

In an embodiment, the second set of members may include a plurality of subsets of members. Each subset of members is associated with a mount level indicating the hierarchical level within the second set of members, wherein the subset of members is stored along with the corresponding mount level. In an example, the “primary” and “secondary” standards of a school may be associated with namespace members with a first mount level, whereas class standard I, II . . . in primary may be associated with namespace members with a second mount level.

In an embodiment, the monitoring unit may generate a root ID corresponding to a root member—member of root repository, a namespace ID corresponding to the namespace member—member of namespace repository and a work ID corresponding to the work member—member of the work repository. In other words, members of the root repository can also be referred to as member repositories. Similarly, members of the namespace and work repository can also be referred to as corresponding member repositories. The root ID, namespace ID, and work ID may correspond to a unique identification key to members of the root repository, namespace repository, and work repository, respectively.

In an embodiment, upon identification of the first, second, the third set of members, the monitoring unit may store the information in memory blocks, wherein a location of memory blocks is stored in the work repository along with the third set of members. In an embodiment, the monitoring unit may generate a root ID indicating a unique identification key corresponding to each of the first set of members. The root ID may be stored along with the first set of members.

In an embodiment, the monitoring unit may generate a knowledge index indicating the location of memory blocks where the knowledge data is stored. Upon generation of the knowledge index, the knowledge index may be stored along with the third set of members. In an embodiment, the monitoring unit may provide access to a user based on the association of the user with the corresponding repository to be accessed.

In an embodiment, the monitoring unit may be configured to obtain login credential details from the user and provide access to the user in case the obtained credential matches with the pre-stored credentials.

In an embodiment, system 100 can be accessed by the one or more computing devices 106 through a website or application that can be configured with any operating system, including but not limited to, Android™, iOS™, Kai-OS™ and the like.

Further, the system 100 can interact with the user through the computing device 106 or through applications residing in the computing device 106. Here the system 100 can obtain a first set of data packets through a first computing device 106 amongst the one or more computing devices 106.

Furthermore, system 100 can also be configured to obtain any or a combination of registration data and sign up details based on a request from a user 110 through a mobile computing device 106. Access to the plurality of repositories may be provided based on login credentials on the acknowledgment of the request and verification of the registration data. In an embodiment, the user may enter the generated login credentials to access the system.

In an embodiment, the user 110 through a computing device 106 with the system 100, may facilitate the user to access, manage and update knowledge and may facilitate the user 110 to operate the system 100.

Subsequently, in an embodiment, the computing device 106 can also function as a display device as well as an interface device with which the user 110 can have an option to visualize and analyze data stored in the plurality of repositories.

Examples of the computing devices can include, but are not limited to, a smartphone, a portable computer, a laptop, a handheld device, a workstation, and the like.

In an embodiment, once the user provides the login credentials and a positive matching of the login credentials is obtained, the system 100 can extract a second set of attributes associated with the first computing device 106, wherein the third set of attributes may correspond to configurable parameters pertaining to any or a combination of communication network, operating systems, database parameters and a plurality of repository structure.

In an exemplary embodiment, the operating system configurable parameters can correspond to configurable applications on choosing an operating system by the user 110. The operating system can include but not limited to, Linux, Vxworks, Windows, Android™, iOS™, etc. This configurable framework can cater for Operating System independency which can be a big advantage to access the system 100.

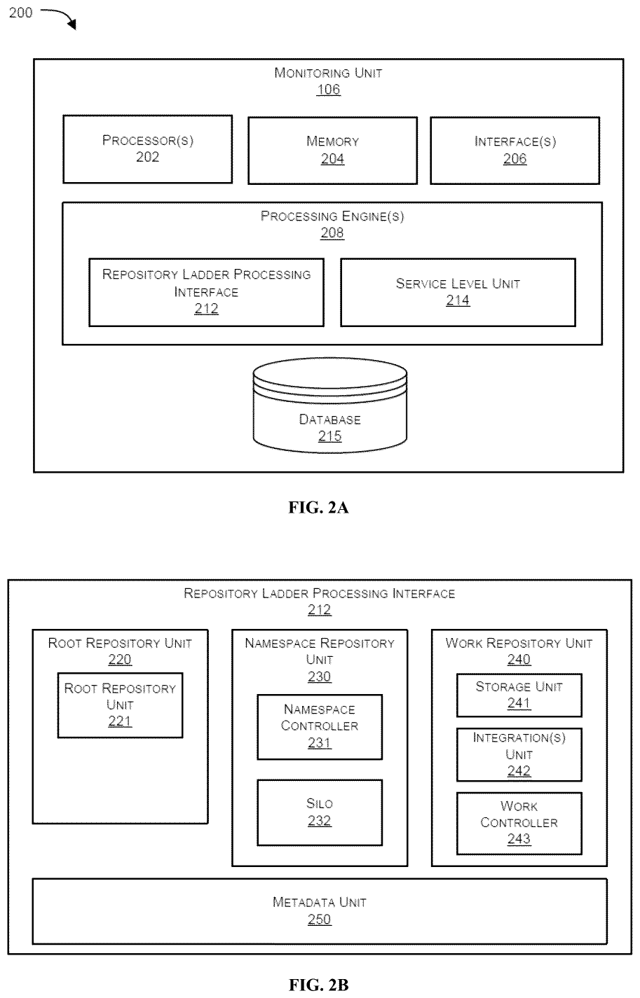

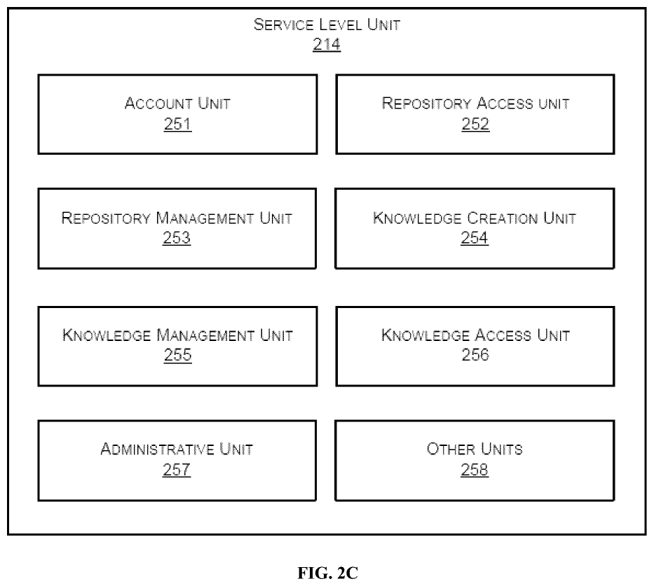

FIGS. 2A-2C illustrates an exemplary architecture of a monitoring unit, repository ladder, and a service level unit, in accordance with embodiments of the present disclosure.

As illustrated, the monitoring unit 102 can include one or more processor(s) 202. The one or more processor(s) 202 can be implemented as one or more microprocessors, microcomputers, microcontrollers, digital signal processors, central processing units, logic circuitries, and/or any devices that manipulate data based on operational instructions. Among other capabilities, the one or more processor(s) 202 can be configured to fetch and execute computer-readable instructions stored in memory 204 of the monitoring unit 102. The memory 204 can store one or more computer-readable instructions or routines, which may be fetched and executed to create or share the data units over a network service. The memory 204 can include any non-transitory storage device including, for example, volatile memory such as RAM, or non-volatile memory such as EPROM, flash memory, and the like.

The monitoring unit 102 can also include an interface(s) 206. The interface(s) 206 may include a variety of interfaces, for example, interfaces for data input and output devices, referred to as I/O devices, storage devices, transducers, actuators, and the like. The interface(s) 206 can facilitate communication of the monitoring unit 102 with various devices coupled to the monitoring unit 102. The interface(s) 206 can also provide a communication pathway for one or more components of the monitoring unit 102. Examples of such components include, but are not limited to, processing engine 208 and database 215.

In another exemplary embodiment, the data packets can be stored in the database 215. Herein, the database 215, can be configured and developed through the interface 206 that can sort a set of data packets according to the nature of the set of data packets and categorize and store the data packets in the plurality of repositories.

Further, the processing engine 208 can be implemented as a combination of hardware and programming (for example, programmable instructions) to implement one or more functionalities of the processing units 208. The database 215 can include data that is either stored or generated because of functionalities implemented by any of the components of the processing units 208.

In an example, the processing engine 208 can include the repository ladder processing interface 212 and the service layer interface (SLI) 214 (also referred to as a service layer unit 214). As illustrated in FIG. 2B, the repository ladder processing interface can include a root repository unit 220, a namespace repository unit 230, a work repository unit 240, and a metadata unit 250.

As illustrated in FIG. 2C, the service layer interface (SLI) (also referred to as a service layer unit 214) can include an accounts unit 251, a repository access unit 252, a repository management unit 253, a knowledge creation unit 254, knowledge management unit 255, a knowledge access unit 256, administration unit 257, and other units 258.

As illustrated in FIG. 2B, the root repository unit 220 may include a root controller 221 that can facilitate the organizing of namespace and work repository in a hierarchical file structure. It allows the hierarchical organization in a tree storage, records arranged in a scheme resembling a tree, with records related to one another from top to bottom. The root controller allows the arrangement of records in a hierarchical order. Alternatively, the root repository unit 220 can arrange the organization structure in acyclic graphs, allowing sharing of namespace repositories.

In an embodiment, the namespace repository unit 230 may further include a namespace controller 231 that can facilitate the creation of members of the namespace repository 230. It further acts as an organizing unit to store and locate the members of the namespace repository 230. The namespace controller 231 additionally provides a silo function 232, where the silo function 232 can override the namespace functionality of the namespace controller 231 to create further namespace members on the basis of its active or inactive state. If the silo function 232 is in an active state, it would override the namespace functionality of the namespace controller 231 to create further members of the namespace repository. In case when the silo function 232 is inactive, no override is initiated on the namespace controller, hence further namespace cells could be created. The silo function 232 can be coupled with an administrator unit to allow an administrator/user to initiate the silo function 232 as per user requirement. The administrator initiates a silo function for the succeeding namespace cell, which indicates that the administrator of the parent member decides for the administrator of the child member whether he could further create namespaces member within an assigned member.

In an embodiment, the work repository unit 240 may further include a storage unit 241 integrations unit 242, and a work controller 243. The work controller 243 facilitates the storage methods consistency and can use a single manifest to create a work repository of a specific storage configuration repetitively. The storage unit 241 manages the storage of knowledge items such as but not limited to, uploading of knowledge items such as electronic files, processing of knowledge items for storage, defining storage location, retrieving the knowledge item from the defined storage location, downloading of a knowledge item, etc. The storage unit 241 can further segregate the metadata of knowledge and the knowledge data itself. The storage unit 241 may update the unique knowledge ID(K_ID) of the stored knowledge in the knowledge index and correspondingly store the knowledge data in the knowledge store in the form of data blocks in the memory blocks. Simultaneously, the storage unit may also store the metadata of knowledge such as name, description, type, the relationship of knowledge item to knowledge in the metadata database associated with the unique knowledge ID(K_ID). The integrations unit 242 acts as an intermediary unit between the storage unit and the other units of SLI to provide various collaboration functionalities such as but not limited to file sharing, comments, messaging, video calls, etc. It allows participants of both sides to interact with each other to fulfil a user operation. It allows various processing units of the service level interface to leverage the processing units of the repository ladder to perform a user operation.

In another embodiment, the repository ladder processing interface 212 may include a metadata unit 250 that can facilitate the storing of the log of data associated with changes due to user operations. The change can include a change in access, position, addition, deletion, edit, etc of the metadata or knowledge data. For example, a change of root repository name or user name, changing the access type of a user, moving a work repository from one namespace repository to another, deleting a user, removing a user from a work repository or namespace repository, etc.

In an embodiment, the service layer unit 214 can provide an accounts unit 251 allowing a user to create an individual or business account with the application. The accounts unit 251 can manage all the account-related information such as personal credentials including but not limited to name, bio, interests, etc; privacy settings, security settings, and other user-relevant information. The accounts unit 251 can also further handle authorization ensuring that a user account attempting to access a repository has appropriate access rights to access the repository.

In an embodiment, the repository access unit 252 can be configured to define and authorize access to a repository among the plurality of repositories. In another embodiment, the repository management unit 253 can be configured to facilitate user operations including but not limited to editing, moving, removing, organizing, updating, etc to a repository among the plurality of the repositories. For example, a user can update the set of members in any of the root repository, namespace repository, and work repository.

In yet another embodiment, the monitoring unit 102 can provide for a knowledge creation unit that facilitates the creation of knowledge. The knowledge can vary from task to task. The knowledge creation unit manages the task-specific knowledge creation methods. For example, a task may require a user to enter some associative information including but not limited to title, description, tags, etc while uploading a video file, the knowledge creation unit can facilitate the process of coupling the associative data with the video file.

In yet another embodiment, the knowledge access unit 256 can be configured to facilitate the access and preview of knowledge in the plurality of repositories in the repository ladder processing interface 212.

In another embodiment, the knowledge management unit 222 can be configured to edit, remove, modify or update knowledge in the plurality of repositories in the repository ladder processing interface 212.

In yet another embodiment, the administration unit 257 can be configured to control the operation of one or more units of the monitoring unit 102. In an example, one or more units can perform corresponding functions upon receiving control signals from the administration unit 257. The repository ladder processing interface 212 may enforce the implementation of organization structure whereas the administrator unit in the SLI ensures the management of organization in a hierarchical structure. In correspondence to the repository ladder, there can be several levels of access depending upon the hierarchy of the organization. However, the administration can be configured on a repository level by access type such as root administrator, namespace administrator, and work administrator.

In an embodiment, each root repository can be accessed by a root administrator or a root user, and similarly, each namespace repository can be accessed by a namespace administrator. Based on the access rights and association with the repository, the root administrator, namespace administrator, and work administrator may differ from each other. The root administrator can have owner access, in which the root administrator can create new members of namespace and work repositories, manage members to the namespace and work repositories, assign an administrator to each member namespace repository e.g., the parent or nested and work repository, delete or move a repository from one namespace repository to another.

In an embodiment, the administrator unit 224 can provide flexibility to create any combination of a subset of namespace members configured to cluster together in a namespace member based on inputs received by the user.

In another embodiment, the stored data in the plurality of repositories can be accessed by a user 110 through the computing device 106 and can be visualized through a display unit coupled to the computing device 106. The structured storage of a set of data packets can make it easier for the user to access the data packets. The data packets stored in the plurality of repositories can be accessed by an application residing in the computing device 106 with an operating system that can include any or a combination of Linux, Vxworks, Windows, Android™, iOS™ and the like.

In an embodiment, as illustrated in FIG. 2B, the repository ladder can further include a root repository or hive 220, a namespace repository or cell 230, and a work repository or wall 240. The root repository 220 acts as a root node for the namespace 230 and work repositories 240. The root repository 220 can store a root ID(R_ID) and first namespace ID(FN_ID). The root ID(R_ID) serves as a unique identification key for the root repository 220. The root repository 220 can further store the first namespace ID(FN_ID) associated with a root repository 220. A first namespace member is the top-most starting node representing a namespace repository in the hierarchical tree structure containing several other nested namespaces repositories. The first namespace repository has no other namespace repository as its parent. In an embodiment, a root repository can store a plurality of first namespace repositories and the first namespace ID(FN_ID) serves as a unique identification key for the first namespace repositories. In another embodiment, multiple root repositories can also simultaneously co-exist in a system, which can be configured by using combinations of databases.

In another embodiment, the namespace repository can store the first namespace ID(FN_ID), nested namespace ID(NN_ID), mount level, and the work repository ID(W_ID). The first namespace ID(FN_ID) as described above, is a unique identification key for a first namespace repository which acts as a root node for its nested namespace repositories. The first and the nested namespace members may be referred to as a subset of members of the namespace repository. The nested namespace ID(NN_ID) is a unique identification key for a distinct nested namespace repository within a first namespace repository. The mount level defines the hierarchical position of a nested namespace repository in the hierarchical tree storage particular to a distinct first namespace repository. In an embodiment, multiple first namespace repositories can simultaneously co-exist in a system, and each individual first namespace repository stores the mount level of its nested namespace repositories. The work repository ID(W_ID) is the unique identification key for a work repository. The namespace repository can act as a sub-directory of the root repository.

In another embodiment, the work repository can store the work repository ID(W_ID) and the knowledge ID(K_ID). The knowledge refers to a file, including but not limited to text, audio, video, programs, etc and its associative data such as title, description, tags, etc inputted by the user to describe the file or inherent metadata of the file like filename, file size, format, etc. Each distinct knowledge has a unique identification key as its knowledge ID(K_ID). A work repository can store the list of all the knowledge IDs associated with the work repository. The work repository can store a plurality of work repository ID(W_ID) and the knowledge ID (K_ID).

In an embodiment, the root repository can store a root ID(H_ID) and First namespace ID(FN_ID). In an embodiment, multiple root members can simultaneously co-exist in a system, where root ID serves as a Unique Identification key among the plurality of members. The root repository can further store the namespace ID of the root namespaces. The root repository also stores namespace members associated with the first mount level, where the mount level of the namespace repository indicates a hierarchical level within the namespace repository. A namespace repository can store the first namespace ID(FN_ID), nested namespace ID (NN_ID), Mount Level, and work ID(W_ID). The work repository can store the Wall ID and Knowledge ID(K_ID).

In another embodiment, the system 100 may communicate with one or more other devices located at a remote location through a communication unit that can include any or a combination of a wireless network module, a wired network module, a dedicated network module, and a shared network module. The communication unit can be configured to any or a combination of protocols such as UDP/TCP Communication, Serial Communication and bus protocols thereby achieving Communication network configurability across various interfaces which can be yet another advantage of the proposed system.

In an embodiment, the server 108, can include a processing engine similar to the processing engine 208 and a database similar to the database 215 to store and organize knowledge in the storage device 112. Further, the server 108 could facilitate the implementation of system 100 over a network 104 for users 110 associated with a computing device 106.

Furthermore, in yet another embodiment, the other unit(s) 226 of the monitoring unit 102 can include an artificial intelligence (AI) engine. The AI engine can be configured to employ artificial intelligence techniques for file or knowledge storage to automatically organize and self-manage the knowledge overtime on the basis of name, description, type, context, and the like to reduce hassle of manual organizing and management.

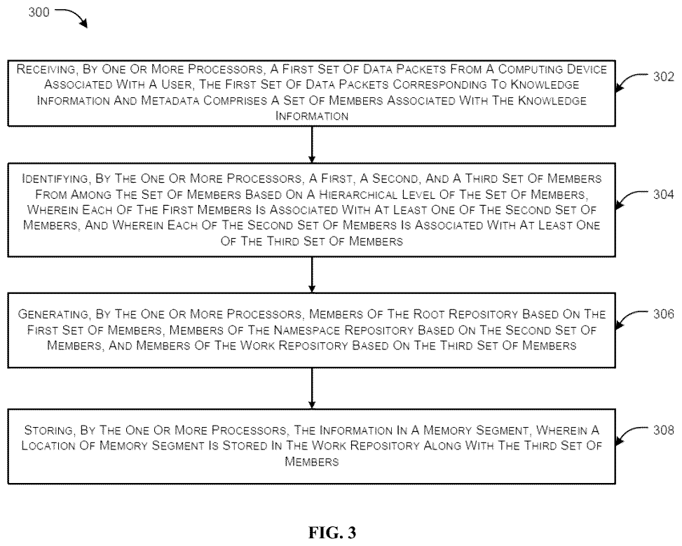

FIG. 3 illustrates an exemplary representation of a flow diagram showing the method for facilitating digital organization structure and management hierarchy in accordance with an embodiment of the present disclosure.

The order in which the method as described is not intended to be construed as a limitation, and any number of the described method blocks can be combined in any order to implement the method or alternate methods. Additionally, individual blocks may be deleted from the method without departing from the spirit and scope of the subject matter described herein. Furthermore, the method can be implemented in any suitable hardware, software, firmware, or combination thereof. However, for ease of explanation, in the embodiments described below, the method may be considered to be implemented in the above-described system.

In an embodiment, the present disclosure provides for the method 300 that may include at block 302 the step of receiving a first set of data packets from a computing device associated with a user, where the first set of data packets corresponds to knowledge data and metadata comprises information of a set of members associated with the knowledge data. Upon receipt of the first set of data packets, at block 304, a first, a second, and the third set of members may be identified from among the set of members based on a hierarchical level of the set of members, wherein each of the first members is associated with at least one of the second set of members, and wherein each of the second set of members is associated with at least one of the third set of members;

Further, at block 306, members of the root repository based on the first set of members, members of the namespace repository based on the second set of members, and members of the work repository based on the third set of members may be generated. Upon generation of members of the root, namespace, and work repository, the knowledge data is stored in a memory segment according to block 308, wherein a location of memory segment is stored in the work repository along with the third set of members.

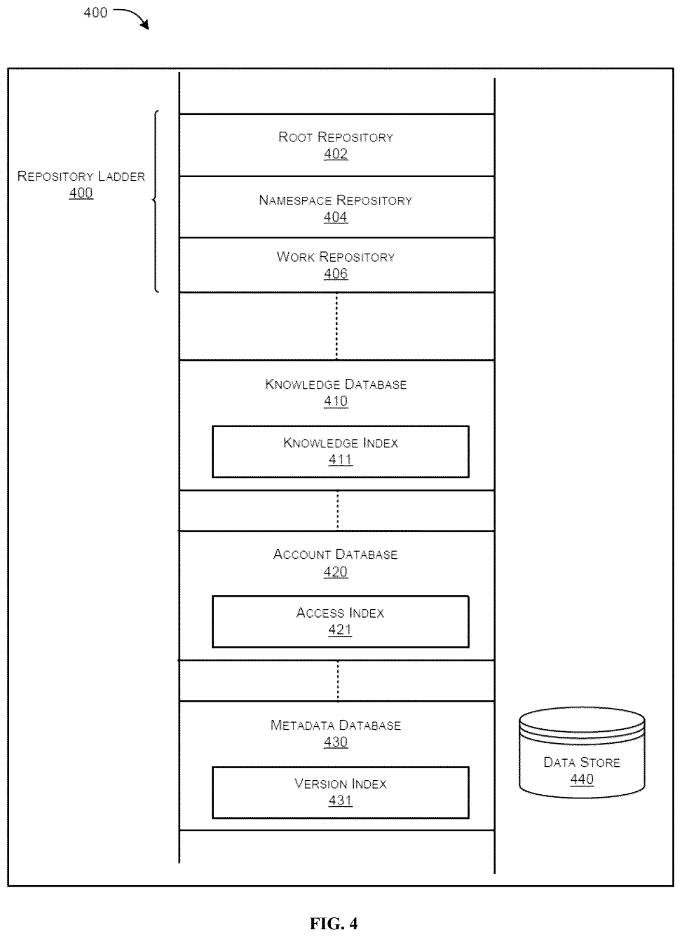

FIG. 4 illustrates a block diagram of an exemplary implementation of logical schema 400 showing the level of interactions between a plurality of repositories in accordance with an embodiment of the present disclosure.

As illustrated in FIG. 4, system 100 implements a plurality of repositories comprising a root repository 402, a namespace repository 404, and a work repository or 406 and maintains knowledge database 410, accounts database 420 and metadata database 430.

In an embodiment, the account database 420 can store personal information such as personal settings, security settings, etc, received from the accounts unit. The personal information stored in the account database 420 may be associated with a unique User Account ID. In another embodiment, the account database 420 can further store an access index 421 which can further store and maintain the repository ID or the identification key of all the repositories associated with an account and the corresponding roles such as administrator and member in each of the listed repositories such as but not limited to User Id U_ID, root ID R_ID, namespace ID-FN_ID, work ID-W_ID and ACCESS TYPE defined for each of the respective repositories. The user can perform a set of functions in a respective repository based on the access type defined to the user in the said repository.

In an embodiment, The knowledge database 410 can store all the knowledge-related data including but not limited to title, description, tags, collaborators, data files, comments, etc. The knowledge database 410 can maintain a record of all the knowledge created or shared in the repository ladder. Each knowledge has a unique knowledge ID associated with the knowledge. The knowledge can be further stored in the form of data blocks in the knowledge store, whereas the knowledge index 411 can maintain the record of all the data blocks stored at the knowledge store. The knowledge index 411 can further be configured on the basis of knowledge type. A knowledge type can be attributed to but not limited to text, video, tables, audio, programs, etc. Similarly, the data blocks of the same knowledge type can also be stored together in the knowledge store. In an embodiment, a knowledge type may be stored as a complete data block whereas a knowledge type with a large size may be split into multiple blocks. Each data block has a unique block ID and similarly if a data block is split into data sub-blocks, each sub-block is assigned a unique sub-block ID which is further associated with a knowledge ID in the knowledge index 411. The knowledge index 411 can further store the location of the data blocks and data sub-blocks in the knowledge store.

In an embodiment, the storage unit 241 can provide a metadata database 430 that can store all the metadata related to the repository ladder, user accounts or any of the participant units of the system. The metadata of the repository ladder can include but not limited toroot repository name, namespace repositories names, work repository names, timestamps of the events for the plurality of repositories, etc. The timestamps can be of various events such as but not limited to, repository creation timestamp, an update timestamp i.e. when a change in a set value is made such as change in name; log in timestamp, log out timestamp, etc. Each metadata record can have a unique attribute ID which can be associated with the unique repository ID of any type of the plurality of repositories. or the User ID. The unique attribute ID may be root repository name (R_Name), First namespace name (FN_Name), Nested Namespaces Names (NN_Name), C_Timstamp, etc. The metadata database can further store the metadata related to a user account. The metadata of the user account can include name, bio, credentials, registration date, etc. In a relational database, the metadata database can store the metadata of the participants unit in multiple tables and which could be spread over multiple databases or devices.

The metadata database 430 may further include a version index 431. The version index 431 maintains the log of all changes or user operations. The version database can include the unique attribute ID of the entity such as Repository or user, action description (such as editing, moving, deletion, etc), timestamp, version number and other associative data. The metadata unit can undo the operations using the version ID or the change history from the metadata database 430.

The following table shows an entry of the root ID (R_ID) R_1, with an organization, and time stamp of repository creation.

TABLE 1

| R_ID | Name | C_Timestamp |
|---|---|---|
| R_1 | ABC Organisation | 2021-11-20 16:45:56 |

Further, the following table shows an entry in the user account metadata against the U_ID, U_2 along with the identity information such as name, date of registration, and contact number.

TABLE 2

| | | | | | | |
|---|---|---|---|---|---|---|
| | | | Date of | | | |
| User_ID | Name | Bio | Registration | Email | Mob_Num | C_Timestamp |

| | | | | | |
|---|---|---|---|---|---|
| U_1 | John Doe | 2021 Nov. 20 | example@email.com | | 2021-11-20 |
| | | | | | 16:45:56 |
| U_2 | Ferdinand | 2021 Nov. 20 | | 1234567890 | 2021-11-20 |
| | Lado | | | | 16:45:56 |

In an embodiment, the storage unit 241 can provide a data store 440 that can store data blocks of knowledge items such as files, videos, etc., and so on. In some embodiments, the knowledge store can be combined with other types of storage and databases to perform certain functions.

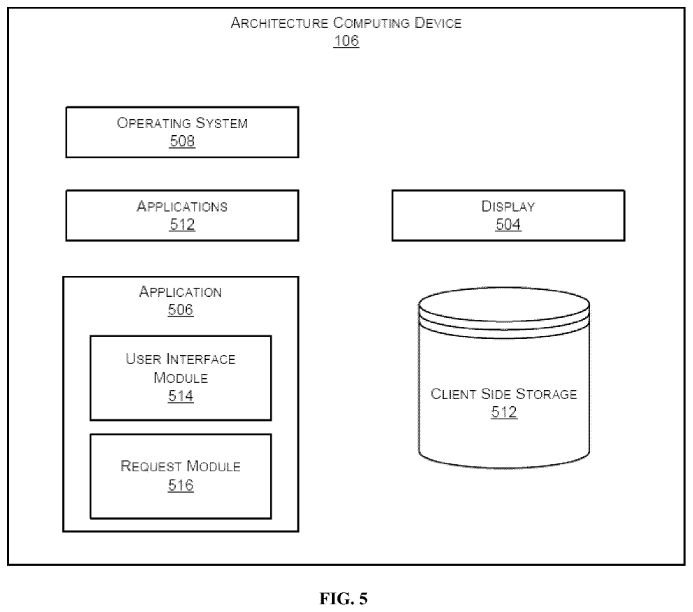

FIG. 5 illustrates an exemplary block diagram depicting components of a computing device 106 associated with a user 110 in accordance with an embodiment of the present disclosure.

As illustrated in FIG. 5, the computing device 106 can include executable instructions 502 (interchangeably referred to as application 502), the display unit 504, operating system 508, and client-side storage 512. The display unit may be configured to provide a graphical user interface between the user and the system. The other applications 518 may vary based on the computing device 106 associated with the user 110 and may include various applications for creating, viewing, consuming, and modifying data stored on the system 100. Application 502 can be associated with the monitoring unit 102 through the network 104. The network 104 can act as a cloud consisting of one or more servers 108 which can execute the programmed functions in the network 104 to associate and generate computer-implemented methods such as but not limited to application 502 coupled to the computing device 106 associated with the user 110. The other applications 518 can be word processors, spreadsheets, database management systems, code editors, image and video editors, e-book readers, audio and video players, and the like. Operating system 508 on one or more computing devices 106 can provide a local environment to execute the application 502 and other applications 518 associated with user interface module 514. Application 502 can be a dedicated application or module that can provide access to the services of the system 100, providing user access to shared data.

In an embodiment, the shared data can be any or a combination of information, metadata, programs, and files through an interface coupled to the computing device 106 associated with the user 110 (interchangeably referred to as the user interface module 514 hereinafter). User 110 may also access system 100 through a web browser included in user interface module 514. In yet another embodiment, the application 502 can include any or a combination of a stand-alone application, an application plug-in, and a browser extension. The client-side storage 512 may include one or more types of non-transitory computer-readable persistent storage media such as any or combination of a hard drive, solid-state memory device, and another form of persistent memory. In an embodiment, the application 502 can also include a request module 516 for creating and sending requests, and the user interface module 514. The application can be a dedicated software or module that can provide access to the services of the system 100, providing both user access to the repository ladder through a user interface, as well as programmatic access for other applications.

In an exemplary implementation, a school environment has been taken into consideration for the below-mentioned exemplary and explanatory purposes. A person skilled in the art would understand that embodiments of the present disclosure do not limit itself to a single environment and thereby can support applications in other business environments correspondingly.

FIG. 6 illustrates an exemplary representation of the hierarchy structure being managed by the proposed system, in accordance with embodiments of the present disclosure. In an educational institute or school, multiple levels of classes may be managed by a head of the department and multiple departments may be managed by the director of the institute. One such exemplary representation of a school is illustrated in FIG. 6, where multiple departments such as ‘Primary’ and ‘Senior Secondary’ are present in a school headed by departmental principals. As illustrated in FIG. 6, the tree structure 600 may indicate a school member that may act as a root node of the hierarchy structure of the school and can be a member of the root repository. The primary and secondary may be members of the first namespace repository with a first mount level, whereas the streams science, arts, and commerce may act as members of the namespace repository with a second mount level within the “secondary” namespace member. Similarly, class standards 1, 2, 3 . . . 5 may act as members of the namespace repository with a second mount level within the “primary” namespace member. Further, class standards 11, 12 may act as members of the namespace repository with a third mount level within the “secondary” namespace member. Further, subjects, hindi, english, physics, chemistry and so on are the respective members of the work repository.

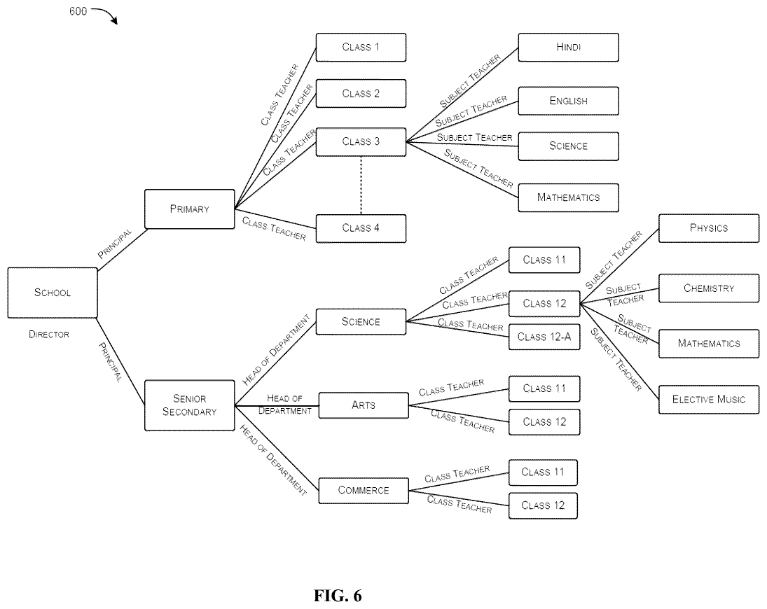

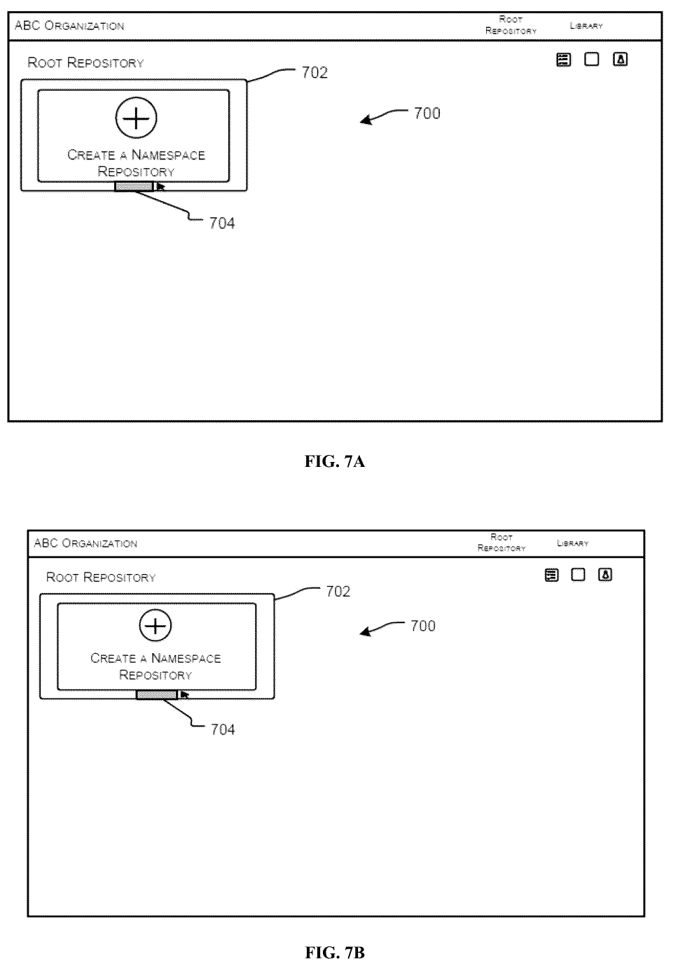

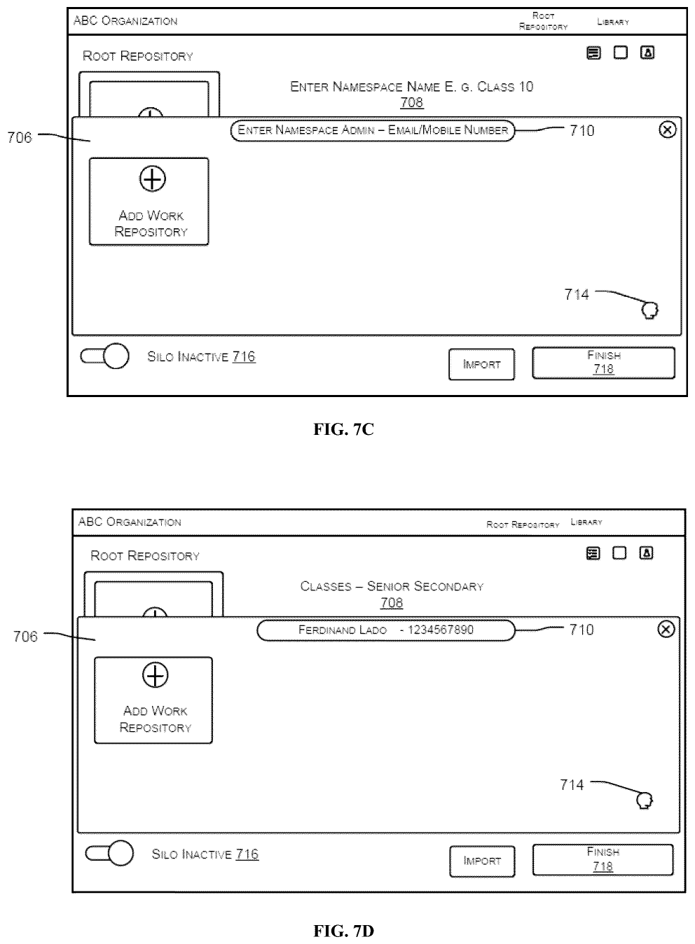

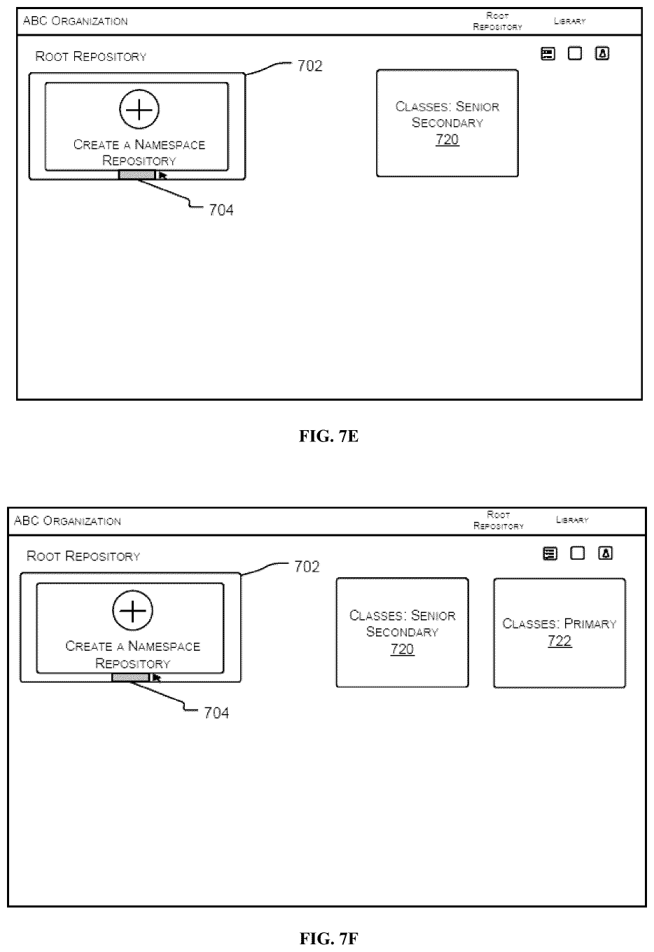

FIGS. 7A-7F illustrates exemplary widgets showing the user interface for receiving the user input, in accordance with embodiments of the present disclosure. FIG. 7A shows an empty canvas 700 and at least one dual-action button 702 with a label of ‘Create a namespace repository’ or ‘Create a work repository’. The dual-action button 702 may initiate and toggle the creation of members of the namespace repository. It consists of a layer switch 704 allowing the initiation of two separate task flows from a single call-to-action depending on if the state of the switch 704 is active state or inactive state.

In an embodiment, the default state of the layer switch 704 is set to active in FIG. 7A. However, the default state is interchangeable and can also be set to inactive. The state of the layer switch 704 can be easily toggled by the administrator to inactive via a single click on it. On switch toggle, any or a combination of the background colors, labels and shape may change indicating the variation of states as shown in FIG. 7B. When the layer switch 704 is in active state and the dual-action button 702 is pressed by the user and process of ‘create a namespace’ gets initiated. When the layer switch 704 is not in an active state, dual-action button 702 is pressed to initiate the process of ‘create a work repository.

In an embodiment, when dual-action button 702 is pressed, a request is sent to a user interface module 514 of the computing device to initiate the creation of a member of the namespace repository as illustrated in FIG. 7C which includes at least one sample representation of the namespace creation.

In an exemplary representation of the embodiment in FIG. 7C, an input field 708 is shown to enter the name of the namespace member. Further, a pill-shaped user interface element 710 (interchangeably referred to as a dual-input pill 710) is shown that allows the user to enter two contextually correlated values together to enter the name and contact information of the administrator. Further, FIG. 7C shows a card size button 712 to add a member of the work repository associated with the namespace member, a button 714 to add members in a namespace repository and a toggle switch 716 to activate or deactivate the silo function and a button 718 to indicate the execution request of the cell creation.

As illustrated in FIG. 7D, the administrator/user of the namespace repository can enter the name of the namespace member in input field 708 and can enter information associated with the administrator such as name, email ID, mobile number in dual input pill 710. The email ID and mobile number can be used as the registration data or login credentials. The user may press ‘Finish’ button 718, a request through the request module is sent to the namespace controller 231 in the repository ladder processing interface 212 of the monitoring unit to create a namespace member. Further, the namespace controller 231 instructs the repository access unit 252 to provide the user with the necessary access type and simultaneously. The work controller then instructs the accounts unit 251 to update the members against the accounts Index/Database 420 and the repository access unit 252 to define access types for the added members

In an embodiment, the proposed system may generate the following table that corresponds to the creation of members of the root repository. The symbol R_1 corresponds to the ID of the school, whereas FN_1 and FN_2 correspond to namespace member “Primary” and “Secondary” respectively.

TABLE 3

| Root ID | Namespace ID |
|---|---|
| (H_id) | (FN_id) |
| R_1 | FN_1 |
| R_1 | FN_2 |

Further, upon creation of members of the namespace repository, the proposed system may generate the following table corresponds to the namespace repository

TABLE 4

| Namespace ID - | Namespace ID | Mount | Work ID |
|---|---|---|---|
| Level 1 (FN_id) | Level 2 (NN_id) | level | (W_id) |
| FN_1 | FN_1_NN_1 | 2 | |
| FN_2 | | 1 | |
| FN_1 | FN_1_NN_2 | 3 | |
| FN_1 | FN_1_NN_2 | 3 | W_1 |
| FN_1 | FN_1_NN_2 | 3 | W_2 |
| FN_1 | FN_1_NN_2 | 3 | W_3 |
| FN_1 | FN_1_NN_2 | 3 | W_4 |

where FN_2 corresponds to first level within the namespace repository, where FN_1_NN_1 correspond to second level within the namespace repository, where work ID corresponds to members of the work repository.

Further, upon creation of members of the work repository, the proposed system may generate the following table corresponds to the work repository.

TABLE 5

| | Root ID | Namespace ID | Work ID | |
|---|---|---|---|---|
| User id | R_id | (C_id) | (W_id) | Access_Type |
| U_1 | R_1 | | | Root_Admin |
| U_2 | R_1 | FN_1 | | Namespace_admin |
| U_3 | R_1 | FN_2 | | Namespace_admin |
| U_4 | R_1 | FN_1_NN_1 | | Namespace_admin |
| U_5 | R_1 | FN_1_NN_2 | | Namespace_admin |
| U_6 | R_1 | FN_1_NN_2 | W_1 | Work_admin |
| U_7 | R_1 | FN_1_NN_2 | W_2 | Work_admin |
| U_8 | R_1 | FN_1_NN_2 | W_3 | Work_admin |
| U_9 | R_1 | FN_1_NN_2 | W_1 | Member |
| U_9 | R_1 | FN_1_NN_2 | W_1 | Member |
| U_9 | R_1 | FN_1_NN_2 | W_1 | Member |
| U_10 | R_1 | FN_1_NN_2 | W_4 | Work_admin |

In an embodiment, the namespace control options are a set of options that allow the namespace administrator to add new members to the namespace repository, remove members from the namespace repository or a specific work repository or modify members access to a specific namespace member. A person skilled in the art may derive multiple such access control for the embodiment.

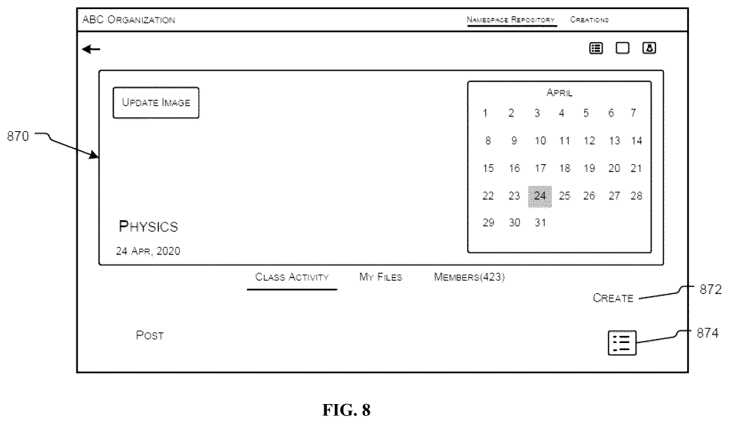

In another embodiment, the work repository can add a user interface on top of the work repository's programming interface to allow users to store data interactively. FIG. 8 illustrates the graphical representation of such embodiment. An administrator or member of a work repository can create knowledge in the said repository. In the exemplary representation, the knowledge can be a video tutorial. As illustrated in FIG. 8, upon pressing the button 874, a request is sent by request module 516 to the user interface module 514 to display the knowledge creation modal. The user may further click on 874 to upload the video file. On receiving user input, the storage unit 241 coupled with the request module may request the operating system to preview the local file system window of the computing device to select the necessary file. The file such as video file can be of various formats like .MP4, .MOV, .WMV, .MKV, etc. The storage unit 241 can facilitate the uploading of the video file and further processing of the video file, finally defining its storage location in the data store. The integration unit 242 can facilitate the interaction between the storage unit 241 and the video tutorial module of the knowledge creation unit 254. The user may fill out the rest of the associative data of the knowledge such as title, description, and tags. On clicking on ‘Finish’ button, the knowledge creation unit 254 or storage unit 241 assigns a knowledge ID to the combined data that constitutes of, a video file, title, description and tags and respectively updates it in the work repository and the knowledge database 410. The knowledge creation unit 254 further instructs the request module 516 to update the user interface. In this manner, the knowledge database 410 maintains the associative data such as title, description, tags against the knowledge ID and knowledge index 411 in the knowledge database 410 and further maintains the record of the data blocks in the data store 440. The following table shows work repositories stored along with knowledge ID.

| Work ID | Knowledge ID |
|---|---|
| W_1 | K_1 |
| W_2 | K_2 |

In an embodiment, the knowledge creation unit 254 can host a variety of program modules and is not limited to only such exemplary implementation. The work repository also does not limit its application to only store knowledge defined in the present explanation but can also store data in the purely content form, such as a single or pluralities of the file of various nature like documents, images, audio, video, etc as stored in a content management system.

An exemplary scenario for the embodiment in the discussion may be that a few member details were not available at the time of creation and they have to be added at a later stage when the namespace repository with few members has already happened. The root administrator may or may not need to perform this task as it also falls under the access level permissions of a namespace administrators and he may be able to do so by accessing the namespace control options present inside the cell.

Thus, the present disclosure provides a multi-level repository structure to facilitate flexible and hierarchical storage and management of knowledge. The multi-level repository structure includes a plurality of repositories, where each of the plurality of repositories is configured to manage knowledge data in a hierarchy structure. The plurality of repositories store metadata associated with the knowledge data. The metadata indicates, for example, users or objects or members to which the knowledge data belongs to, the location of the memory where the knowledge data is being stored, and so on. The metadata information e.g., members associated with the knowledge data are stored in a hierarchy structure.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

### ADVANTAGES OF THE PRESENT DISCLOSURE

Some of the advantages of the present disclosure, which at least one embodiment herein satisfies are as listed herein below.

The present disclosure provides for a system and method for setting a unique and flexible structure to storage and management of knowledge that does not vary from application to application and organisation to organisation.

The present disclosure provides for an approach that enables uniformity in the system's operability.

The present disclosure provides for an approach for enabling flexibility to users to create storage space that caters to the specificities of the organisation and application requirements of the users.

The present disclosure provides for a system and method that facilitates multiple repository structures to explain storage-related functionalities.

The present disclosure provides for an approach for a flexible and hierarchical repository to configure the knowledge management system as per the requirements of a user irrespective of any application.

The present disclosure provides for a system and method that enables an application to be designed, created and edited from scratch for businesses, employees and end-users.

The present disclosure provides for a system and method that facilitates a user to have control over the creation of a new storage tier and arrangement of repositories among different tiers without the requirement of manual programming.

The present disclosure provides for a system and method for the creation of categories and classifications in which the knowledge can be organized with multiple functionalities associated with it.

The present disclosure provides for a system to enable a flexible knowledge and storage structure that is not customer specific and to facilitate one domain to be implemented in another domain without any manual programming.

The present disclosure provides for an approach to define an association between independent repositories to promote resource and data sharing, which contributes to the connectivity of the overall system.

We claim:

1. A knowledge management system comprising:
a storage device including a plurality of repositories operatively coupled to one or more computing devices, the plurality of repositories can be configured to store knowledge data and metadata associated with the knowledge data in a hierarchical manner, the plurality of repositories comprises a root repository, a namespace repository, and a work repository, wherein members of the root repository, namespace repository, and work repository are associated with each other in a hierarchical manner; and
a monitoring unit having a processor operatively coupled to a memory, the memory storing instructions executable by the processor to:
receive a first set of data packets from a computing device associated with a user, the first set of data packets corresponding to knowledge data and metadata comprises information of a set of members associated with the knowledge data;
identify a first, a second, and a third set of members from among the set of members based on a hierarchical level of the set of members, wherein each of the first members is associated with at least one of the second set of members, and wherein each of the second set of members is associated with at least one of the third set of members;
generate members of the root repository based on the first set of members, members of the namespace repository based on the second set of members, and members of the work repository based on the third set of members; and
store the knowledge data in the corresponding member of the work repository and store metadata associated with each repository in the corresponding repositories.

2. The system as claimed in claim 1, wherein the second set of members comprises a plurality of subsets of members, wherein each subset of members is associated with a mount level indicating the hierarchical level within the namespace repository, wherein the subset of members is stored along with the corresponding mount level, wherein the namespace members are associated with a silo function that creates further namespace members on the basis of its active or inactive state.

3. The system as claimed in claim 1, wherein the processor is configured to:
generate a root ID indicating a unique identification key corresponding to each of the members of the root repository;
generate a namespace ID indicating a unique identification key corresponding to each of the members of the namespace repository;
generate a work ID indicating a unique identification key corresponding to each of the members of the work repository; and
store the root ID along with the first set of members, the namespace ID along with the second set of members and work ID along with the third set of members.

4. The system as claimed in claim 1, wherein the processor is configured to:
generate a knowledge index indicating the location of memory blocks where the knowledge data is stored and type of the knowledge data; and
store the knowledge index along with the third set of members.

5. The system as claimed in claim 1, wherein the processor is configured to provide access to a user based on the association of the user with the corresponding repository to be accessed.

6. The system as claimed in claim 5, wherein the processor is configured to obtain login credential details from the user and provide access to the user in case the obtained credential matches with the pre-stored credentials.

7. The system as claimed in claim 1, wherein the processor is configured to maintain an account database to store identification key of the plurality of repositories.

8. The system as claimed in claim 1, wherein the computing device comprises a display unit configured to provide a graphical user interface between the user and the system.

9. A method for facilitating hierarchical storage and management of knowledge, the method comprising:
receiving, by one or more processors, a first set of data packets from a computing device associated with a user, the first set of data packets corresponding to knowledge data and metadata, wherein metadata comprises information of a set of members associated with the knowledge data;
identifying, by the one or more processors, a first, a second, and a third set of members from among the set of members based on a hierarchical level of the set of members, wherein each of the first members is associated with at least one of the second set of members, and wherein each of the second set of members is associated with at least one of the third set of members;
generating, by the one or more processors, members of the root repository based on the first set of members, members of the namespace repository based on the second set of members, and members of the work repository based on the third set of members; and
storing, by the one or more processors, the knowledge data in the corresponding work repository and storing metadata associated with each repository in the corresponding repositories.
